(19) United States
(12) Patent Application Publication
(10) Pub. No.: US 2020/0367289 A1
(43) Pub. Date: Nov. 19, 2020

(54) METHOD AND APPARATUS FOR TRANSMITTING OR RECEIVING DATA THROUGH UPLINK CARRIER IN WIRELESS COMMUNICATION SYSTEM

(71) Applicant: Samsung Electronics Co., Ltd., Gyeonggi-do (KR)

(72) Inventors: Seung Hoon CHOI, Gyeonggi-do (KR); Young Bum KIM, Gyeonggi-do (KR); Tae Hyoung KIM, Gyeonggi-do (KR); Tae Han BAE, Gyeonggi-do (KR)

(21) Appl. No.: 16/764,759

(22) PCT Filed: Nov. 15, 2018
(86) PCT No.: PCT/KR2018/014007

§ 371 Date: May 15, 2020

(30) Foreign Application Priority Data
Nov. 16, 2017 (KR) 10-2017-0153352

(51) Int. Cl. H04W 74/08; H04W 74/00; H04W 24/10; H04B 17/318; H04L 5/00

(52) U.S. Cl. CPC H04W 74/0833; H04W 74/006; H04L 5/0098; H04W 24/10; H04B 17/318; H04W 74/004

(57) ABSTRACT

The present disclosure relates to a method for transmitting or receiving data through a supplementary uplink carrier (SUL carrier) in a wireless communication system, the method comprising the steps of: receiving, from a base station, random access channel configuration (RACH configuration) information in the supplementary uplink carrier through a cell common signal of a downlink component carrier (downlink carrier: DL carrier); measuring a reference signal received power (RSRP) in the downlink component carrier; comparing the measured reference signal received power with a threshold for selection of the supplementary uplink carrier; and when the measured reference signal received power is smaller than the threshold, performing random access in the supplementary uplink carrier, wherein the threshold for the selection of the supplementary uplink carrier is included in the random access channel configuration information.

### CROSS-REFERENCE TO RELATED APPLICATION(S)

This application is a National Phase Entry of PCT international Application No. PCT/KR2018/014007, which was filed on Nov. 15, 2018, and claims priority to Korean Patent Application No. 10-2017-0153352 filed on Nov. 16, 2017, in the Korean Intellectual Property Office, the contents of which are incorporated herein by reference.

### BACKGROUND

### 1. Field

The present disclosure relates to a method and apparatus to transmit and receive data through an uplink carrier in a wireless communication system.

### 2. Description of the Related Art

To meet the demand for wireless data traffic, which has increased since deployment of 4th-Generation (4G) communication systems, efforts have been made to develop an improved 5th-Generation (5G) or pre-5G communication system. Therefore, the 5G or pre-5G communication system is also called a beyond 4G network communication system or a post LTE system.

It is considered that the 5G communication system will be implemented in millimeter wave (mmWave) bands, e.g., 60 GHz bands, so as to accomplish higher data rates. To reduce propagation loss of radio waves and increase a transmission distance, a beam forming technique, a massive multiple-input multiple-output (MIMO) technique, a full dimensional MIMO (FD-MIMO) technique, an array antenna technique, an analog beam forming technique, and a large scale antenna technique are discussed in 5G communication systems.

In addition, in 5G communication systems, development for system network improvement is under way based on advanced small cells, cloud radio access networks (RANs), ultra-dense networks, a device-to-device (D2D) communication, a wireless backhaul, a moving network, a cooperative communication, coordinated multi-points (CoMP), reception-end interference cancellation, and/or the like.

In a 5G system, a hybrid FSK and QAM modulation (FQAM) and a sliding window superposition coding (SWSC) as an advanced coding modulation (ACM) scheme, and a filter bank multi carrier (FBMC), a non-orthogonal multiple access (NOMA), a sparse code multiple access (SCMA), and/or the like as an advanced access technology have been developed.

### SUMMARY

In 5G, when a terminal accesses on a specific frequency band, uplink transmission coverage may be limited due to a characteristic of the frequency band. In this case, it is possible to improve the uplink transmission coverage by transmitting, to the terminal, information about a supplementary uplink carrier of a frequency band which has a good uplink transmission coverage to cause the terminal to transmit an uplink signal through the supplementary uplink carrier. At this time, the present disclosure provides a solution for activating/deactivating a supplementary uplink carrier. Also, the present disclosure provides a solution for generating a bit field of a downlink control channel in case that aperiodic channel information is transmitted through the supplementary uplink carrier. In addition, the present disclosure provides a solution for indicating, to the terminal, information on which downlink carriers to perform channel information transmission by setting association with channel information transmission for specific downlink carriers when aperiodic channel information is transmitted.

The present disclosure relates to a method for transmitting and receiving data through a supplementary uplink (SUL) carrier in a wireless communication system, and the method comprises receiving, from a base station, random access configuration (random access channel (RACH) configuration) information on a supplementary uplink carrier through a cell common signal of a downlink component carrier (downlink (DL) carrier); measuring reference signal received power (RSRP) on the downlink component carrier; comparing the measured reference signal received power with a threshold for selecting the supplementary uplink carrier; and performing a random access on the supplementary uplink carrier in case that the measured reference signal received power is less than the threshold, wherein the threshold for selecting the supplementary uplink carrier is included in the random access configuration information.

The present disclosure provides a solution for activating/deactivating a supplementary uplink carrier when uplink transmission is performed through the supplementary uplink carrier in a 5G communication system, and enables efficient data transmission and reception through aperiodic channel information transmission and reception by indicating a specific downlink carrier for the aperiodic channel information transmission and reception when the supplementary uplink carrier is configured and activated.

### BRIEF DESCRIPTION OF THE DRAWINGS

FIG. 1 is a diagram illustrating a basic structure of a time-frequency domain in LTE;

FIG. 2 is a diagram illustrating a transmission resource of a downlink control channel and a downlink data channel in LTE;

FIG. 3 is a diagram illustrating a transmission resource of a 5G downlink control channel;

FIG. 4 is a diagram illustrating a transmission resource of a 5G downlink control channel and a 5G downlink data channel;

FIG. 5 is a diagram illustrating a communication system according to an embodiment of the present disclosure;

FIG. 6 is a diagram illustrating general 5G carrier aggregation;

FIG. 7 is a diagram illustrating a case that 5G uplink and downlink carriers and a supplementary uplink carrier are configured according to an embodiment of the present disclosure;

FIG. 8 is a diagram illustrating a method to additionally configure a supplementary uplink carrier for an NR cell and perform an initial random access according to time sequence, according to an embodiment of the present disclosure;

FIG. 9 is a diagram illustrating a solution to indicate activation/deactivation of a supplementary uplink carrier according to an embodiment of the present disclosure;

FIG. 10 is a diagram illustrating a case that aperiodic channel information triggering is transmitted in case that a supplementary uplink carrier is configured for 5G uplink and downlink carriers according to an embodiment of the present disclosure;

FIG. 11 is a diagram illustrating a structure of a terminal apparatus according to an embodiment of the present disclosure; and

FIG. 12 is a diagram illustrating a structure of a base station apparatus according to an embodiment of the present disclosure.

### DETAILED DESCRIPTION

Embodiments of the present disclosure will be described in detail with reference to the attached drawings. A detailed description of a generally known function or structure of the present disclosure will be avoided lest it should obscure the subject matter of the present disclosure. Although terms as described below are defined in consideration of functions in the present disclosure, the terms may be changed according to the intention of a user or an operator, or customs. Therefore, the present disclosure should be understood, not simply by the actual terms used but by the meanings of each term lying within.

Hereinafter, although embodiments of the present disclosure will be described with reference to, for example, a new radio (NR) system, the embodiments of the present disclosure may be applied to other communication systems having similar technical backgrounds and channel types. So, the embodiments of the present disclosure may be applied to other communication systems by those skilled in the art of the present disclosure without departing from the scope of the present disclosure and with slight modification.

Before a detailed description of the present disclosure, exemplary meanings as which some terms used in the present disclosure are interpretable will be given below. However, it should be understood that the terms are not limited to the following interpretation examples.

Hereinafter, a base station is a subject which performs resource allocation for a terminal, and may be at least one of an eNode B, a Node B, a base station (BS), a radio access unit, a base station controller, or a node on a network. A terminal may include a user equipment (UE), a mobile station (MS), a cellular phone, a smart phone, a computer, or a multimedia system which may perform a communication function. In the present disclosure, an uplink (UL) means a radio transmission path of a signal transmitted from a terminal to a base station.

A wireless communication system has developed into a broadband wireless communication system that provides a high speed and high quality packet data service, such as a communication standard, for example, high speed packet access (HSPA) and long term evolution (LTE) or evolved universal terrestrial radio access (E-UTRA), LTE-advanced (LTE-A), LTE-Pro of 3GPP, high rate packet data (HRPD) and ultra mobile broadband (UMB) of 3GPP2, and 802.16e of IEEE, and/or the like, beyond the voice-based service provided at the initial stage.

An LTE system which is a representative example of the broadband wireless communication system employs an orthogonal frequency division multiplexing (OFDM) scheme for a downlink (DL), and a single carrier frequency division multiple access (SC-FDMA) scheme for an uplink (UL). The uplink denotes a radio link in which a terminal (user equipment (UE) or mobile station (MS)) transmits data or a control signal to a base station (eNode B or base station (BS)), and the downlink denotes a radio link in which the base station transmits data or a control signal to the terminal. In the multiple access schemes as described above, time-frequency resources for carrying data or control information are allocated and operated in a manner to prevent overlapping of the time-frequency resources, that is, to establish orthogonality between users so as to identify data or control information of each user.

A 5G communication system as a communication system after LTE is required to support a service that simultaneously satisfies various requirements in order to freely reflect various requirements, such as requirements from users, service providers, or the like. Services which are being considered for the 5G communication system include an enhanced mobile broadband (eMBB), a massive machine type communication (mMTC), an ultra reliability low latency communication (URLLC), and/or the like.

eMBB is to provide an enhanced data rate compared to a data rate supported by conventional LTE, LTE-A or LTE-Pro. For example, in the 5G communication system, eMBB needs to provide a peak data rate of 20 Gbps in the downlink and a peak data rate of 10 Gbps in the uplink from the perspective of one eNB. Also, the 5G communication system needs to provide an enhanced user perceived data rate at the same time as providing a peak data rate. To satisfy the above described requirements, improvement of various transmission and reception technologies including an enhanced multi-input multi-output (MIMO) transmission technology is required. Also, LTE conventionally transmits a signal using a maximum transmission bandwidth of 20 MHz in a 2 GHz band, whereas the 5G communication system uses a frequency bandwidth wider than 20 MHz in a frequency band of 3 to 6 GHz or a frequency band of 6 GHz or more, whereby a data rate required by the 5G communication system may be satisfied.

At the same time, mMTC is being considered for the 5G communication system so as to support an application service, such as Internet of Things (IoT). mMTC requires massive terminal access supported in a cell, improvement of a terminal coverage, improved battery time, decrease in expenses of a terminal, and/or the like, so as to efficiently provide IoT. IoT provides a communication function through attachment to various sensors and various devices, whereby IoT needs to support a large number of terminals in a cell (e.g., 1,000,000 terminals/km²). Also, a terminal that supports mMTC has a high probability of being located in a shadow area that is not covered by a cell, such as a basement of a building, due to a characteristic of the service, the terminal requires a larger coverage than other services provided in the 5G communication system. The terminal supporting mMTC needs to be a low-price terminal, and is required to have a significantly long battery life time such as 10 to 15 years since it is difficult to frequently change the battery of the terminal.

URLLC is a mission-critical cellular-based wireless communication service. For example, services used for remotely controlling a robot or machinery, industrial automation, an unmanned aerial vehicle, remote health care, emergency alert, and/or the like may be considered. Therefore, communication provided by URLLC needs to provide a significantly low latency and significantly high reliability. For example, a service that supports URLLC needs to satisfy an air interface latency less than 0.5 ms and simultaneously to satisfy a packet error rate less than 10⁻⁵. Therefore, for the service supporting URLLC, the 5G system needs to be designed to provide a smaller transmit time interval (TTI) than other services, and simultaneously to allocate a wide resource in a frequency band in order to secure the reliability of a communication link.

Three services of 5G, i.e., eMBB, URLLC, and mMTC may be multiplexed and transmitted in one system. At this time, different transmission and reception schemes and transmission and reception parameters may be used among services to satisfy different requirements of the services.

Hereinafter, a frame structure of long term evolution (LTE) and LTE-advanced (LTE-A) systems will be described with reference to the drawings.

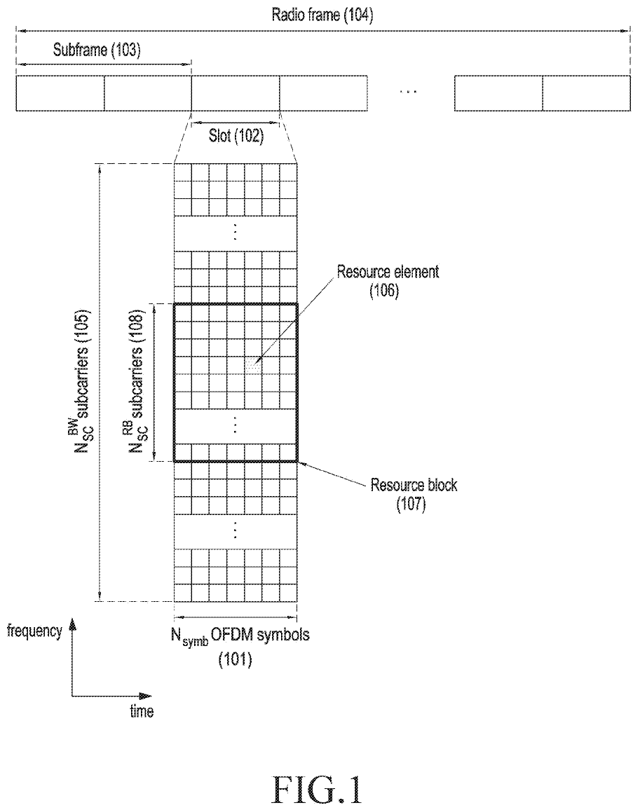

FIG. 1 is a diagram illustrating a basic structure of a time-frequency domain as a radio resource region in which the data or control channel is transmitted in a downlink of an LTE system.

Referring to FIG. 1, a horizontal axis represents a time domain, and a vertical axis represents a frequency domain. In the time domain, a minimum transmission unit is an OFDM symbol, and one slot 102 includes N_{symb} OFDM symbols 101, and one subframe 103 includes two slots. A length of the slot is 0.5 ms, and a length of a subframe is 1.0 ms.

A radio frame 104 is a time domain unit including 10 subframes. In the frequency domain, a minimum transmission unit is a subcarrier, and a transmission bandwidth of an overall system transmission band includes a total of NBW subcarriers 105. In a time-frequency domain, a basic resource unit is a resource element (RE) 106, and the RE 106 is expressed by an OFDM symbol index and a subcarrier index. A resource block (RB) (or physical resource block (PRB)) 107 is defined by consecutive Nsymb OFDM symbols 101 in the time domain and consecutive NRB subcarriers 108 in the frequency domain. So, one PRB 107 includes Nsymb×NRB REs 106. Generally, a minimum transmission unit for data is the RB. In an LTE system, generally, Nsymb=7 and NRB=12, and NBW and NRB are proportional to a bandwidth of a system transmission band.

Subsequently, downlink control information (DCI) in LTE and LTE-A systems will be described in detail.

In an LTE system, scheduling information for downlink data or uplink data is transferred from a base station to a terminal through DCI. The DCI defines various formats, and a determined DCI format may be applied and operated based on whether the DCI is scheduling information for uplink data or scheduling information for downlink data, whether the DCI is compact DCI with small-size control information, whether spatial multiplexing using a multi-antenna is applied, whether the DCI is for power control, and/or the like. For example, DCI format 1, which is scheduling control information for downlink data, is configured to include at least the following control information.

Resource allocation type 0/1 flag: indicating whether a resource allocation type is type 0 or type 1. Type 0 is a resource allocation type which allocates a resource in a unit of a resource block group (RBG) by applying a bitmap scheme. In an LTE system, a basic unit of scheduling is a resource block (RB) expressed by time and frequency domain resources, and an RBG includes a plurality of RBs and is used as a basic unit of scheduling in the type 0 scheme. Type 1 is a resource allocation type which allocates a specific RB within an RBG.

Resource block assignment: indicating an RB allocated to data transmission. A resource to be expressed is determined based on a system bandwidth and a resource allocation scheme.

Modulation and coding scheme (MCS): indicating a modulation scheme used for data transmission and a size of a transport block which is data to be transmitted.

Hybrid automatic repeat and request (HARQ) process number: indicating a process number of HARQ.

New data indicator: indicating whether transmission is HARQ initial transmission or retransmission.

Redundancy version: indicating a redundancy version of HARQ.

Transmit power control (TPC) command for physical uplink control channel (PUCCH): indicating a TPC command for a PUCCH which is an uplink control channel.

The DCI is transmitted through a physical downlink control channel (PDCCH) or an enhanced PDCCH (E-PDCCH) after a channel coding and modulation process.

A cyclic redundancy check (CRC) is attached to a payload of a DCI message, and the CRC is scrambled to a radio network temporary identifier (RNTI) corresponding to identification of a terminal. Based on a purpose of the DCI message, for example, terminal-specific (UE-specific) data transmission, power control command, random access response, and/or the like, different RNTIs are used. That is, an RNTI is not transmitted explicitly, but transmitted by being included in a CRC calculation process. When a terminal receives a DCI message transmitted on a PDCCH, the terminal checks a CRC using an allocated RNTI, and may identify that a corresponding message is transmitted to the terminal in a case that the CRC check result is successful.

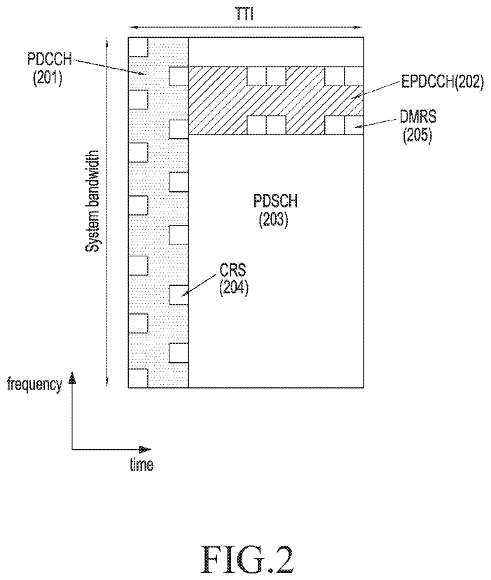

FIG. 2 is a diagram illustrating a transmission resource of a downlink control channel and a downlink data channel in LTE.

FIG. 2 illustrates a PDCCH 201 and an enhanced PDCCH (EPDCCH) 202, which are downlink physical channels through which DCI is transmitted, in LTE.

Referring to FIG. 2, a PDCCH 201 is time-multiplexed with a PDSCH 203 which is a data transmission channel, and is transmitted across an entire system bandwidth. A region of the PDCCH 201 is expressed by the number of OFDM symbols, and is indicated to a terminal with a control format indicator (CFI) transmitted through a physical control format indicator channel (PCFICH). By allocating the PDCCH 201 to an OFDM symbol located in the forepart of a subframe, the terminal may immediately decode downlink scheduling allocation, whereby decoding delay for a downlink shared channel (DL-SCH), i.e., overall downlink transmission delay, may be reduced. One PDCCH carries one DCI message, a plurality of terminals may be simultaneously scheduled in a downlink and an uplink, and thus, a plurality of PDCCHs is simultaneously transmitted in each cell. A CRS 204 is used as a reference signal for decoding the PDCCH 201. The CRS 204 is transmitted in each subframe across an entire band, and scrambling and resource mapping are changed based on a cell identity (ID). The CRS 204 is a reference signal used by all terminals in common, and thus, terminal-specific beamforming may not be used. So, a multi-antenna transmission scheme for a PDCCH of LTE is limited to open-loop transmission diversity. The number of ports of a CRS is implicitly known to a terminal through decoding of a physical broadcast channel (PBCH).

Resource allocation for the PDCCH 201 is based on a control-channel element (CCE), and one CCE includes 9 resource element groups (REGs), i.e., a total of 36 resource elements (REs). The number of CCEs required for the PDCCH 201 may be 1, 2, 4, or 8, which is changed based on a channel coding rate of a DCI message payload. As described above, different values of the number of CCEs are used for implementing a link adaptation of the PDCCH 201. A terminal needs to detect a signal in a state of not knowing of information about the PDCCH 201, and LTE defines a search space representing a set of CCEs for blind decoding. A search space includes a plurality of sets in an aggregation level (AL) of each CCE, and the AL is not explicitly signaled but is defined implicitly through a function by a terminal identity and a subframe number. In each subframe, a terminal performs decoding for the PDCCH 201 for all possible resource candidates which may be made from CCEs within a configured search space, and processes information which has been indicated to the terminal as valid information through CRC check.

The search space is classified into a terminal-specific search space and a common search space. Terminals in a set group or all terminals may check a common search space for the PDCCH 201 so as to receive cell-specific control information, such as dynamic scheduling for system information or a paging message. For example, scheduling allocation information of a DL-SCH for transmission of a system information block (SIB)-1 including cell operator information, and/or the like may be received by checking a common search space for the PDCCH 201.

According to FIG. 2, an EPDCCH 202 is frequency-multiplexed with the PDSCH 203, and is transmitted. A base station may appropriately allocate resources of the EPDCCH 202 and the PDSCH 203 through scheduling, thereby efficiently supporting coexistence with data transmission for a legacy LTE terminal. However, the EPDCCH 202 is transmitted by being allocated to the entirety of one subframe in a time axis, whereby there is a loss from the perspective of transmission delay time. One EPDCCH 202 set includes a plurality of EPDCCHs 202, and allocation of the EPDCCH 202 set is performed based on a physical resource block (PRB) pair unit. Location information for an EPDCCH set is terminal-specifically set, and is signaled to a terminal through a radio resource control (RRC). A maximum of two EPDCCH 202 sets may be configured for each terminal, and one EPDCCH 202 set may be simultaneously multiplexed and configured for different terminals.

Resource allocation for the EPDCCH 202 is based on an enhanced CCE (ECCE), and one ECCE may include 4 or 8 enhanced REGs (EREGs), and the number of EREGs per ECCE may vary based on a length of a CP and subframe configuration information. One EREG includes 9 REs, whereby 16 EREGs may be included in each PRB pair. An EPDCCH transmission scheme is classified into a localized transmission scheme and a distributed transmission scheme based on an RE mapping scheme of an EREG. An aggregation level of the ECCE may be 1, 2, 4, 8, 16, or 32, which is be determined based on the length of the CP, subframe configuration, an EPDCCH format, and a transmission scheme.

The EPDCCH 202 supports only a terminal-specific search space. So, a terminal which desires to receive a system message needs to search for a common search space on the existing PDCCH 201.

In the EPDCCH 202, a demodulation reference signal (DMRS) 205 is used as a reference signal for decoding. So, pre-coding for the EPDCCH 202 may be set by a base station, and terminal-specific beamforming may be used. Even though terminals may not know which pre-coding is used through the DMRS 205, the terminals may perform decoding of the EEPDCCH 202. In the EPDCCH 202, the same pattern as that of a DMRS of the PDSCH 203 is used. However, unlike the PDSCH 203, the DMRS 205 for the EPDCCH 202 may support transmission using a maximum of four antenna ports. The DMRS 205 is transmitted in a corresponding PRB in which an EPDCCH is transmitted.

Port configuration information of the DMRS 205 is changed based on a transmission scheme of the EPDCCH 202. In a localized transmission scheme, an antenna port corresponding to an ECCE to which the EPDCCH 202 is mapped is selected based on an identifier (ID) of a terminal. In a case that different terminals share the same ECCE, that is, multiuser MIMO transmission is used, an antenna port of the DMRS 205 may be allocated to each of terminals. Alternatively, the terminals may share and transmit the DMRS 205. In this case, the antenna port of the DMRS 205 may be identified based on a DMRS 205 scrambling sequence set by higher layer signaling. In a distributed transmission scheme, a maximum of two antenna ports of the DMRS 205 are supported, and a diversity scheme of a pre-coder cycling scheme is supported. The DMRS 205 may be shared for all REs transmitted within one PRB pair.

In LTE, a total PDCCH region includes a set of CCEs in a logical region, and a search space including a set of CCEs exists in the total PDCCH region. The search space is classified into a common search space and a terminal-specific search space, and a search space for an LTE PDCCH is defined as the following.

The set of PDCCH candidates to monitor are defined in terms of search spaces, where a search space Sₖ^{(L)} at
aggregation level L ϵ {1, 2, 4, 8} is defined by a set of PDCCH candidates. For each serving cell on which
PDCCH is monitored, the CCEs corresponding to PDCCH candidate m of the search space Sₖ^{(L)} are given by
L {(Yₖ + m′)mod └N_{CCE, k}/L┘} + i
where Yₖ is defined below, i = 0, L, L − 1. For the common search space m′ = m. For the PDCCH UE specific
search space, for the serving cell on which PDCCH is monitored, if the monitoring UE is configured with
carrier indicator field then m′ = m + M^{(L)} · n_{CI} where n_{CI} is the carrier indicator field value, else if the
monitoring UE is not configured with carrier indicator field then m′ = m, where m = 0, L, M^{(L)} − 1. M^{(L)} is the
number of PDCCH candidates to monitor in the given search space.
Note that the carrier indicator field value is the same as ServCellIndex
For the common search spaces, Yₖ is set to 0 for the two aggregation levels L = 4 and L = 8.
For the UE-specific search space Sₖ^{(L)} at aggregation level L, the variable Yₖ is defined by
Yₖ = (A · Yₖ₋₁)mod D
where Y₋₁ = n_{RNTI} ≠ 0, A = 39827, D = 65537 and k = └nₛ/2┘, nₛ is the slot number within a radio frame.
The RNTI value used for n_{RNTI} is defined in subclause 7.1 in downlink and subclause 8 in uplink.

According to the definition of the search space for the PDCCH as described above, a terminal-specific search space is not explicitly signaled and is implicitly defined through a function and a subframe number by a terminal identity. In other words, the terminal-specific search space may be changed according to the subframe number, and this means that it can be changed according to time. Through this, a problem that a specific terminal may not use a search space due to other terminals among the terminals (it is defined as a blocking problem) is solved. In a case that a terminal may not be scheduled in a subframe since all CCEs which the terminal searches are used by other terminals which are already scheduled in the same subframe, this search space changes according to time, so this problem may not occur in the next subframe. For example, even if a part of terminal-specific search spaces of terminal #1 and terminal #2 is overlapped, a terminal-specific search space changes per subframe, so an overlap in the next subframe may be expected to be different from this.

According to the definition of the search space for the PDCCH as described above, in a case of a common search space, a certain group of terminals or all terminals need to receive the PDCCH, so it is defined as a set of predetermined CCEs. In other words, the common search space does not change according to an identity of a terminal or a subframe number. Although a common search space exists for transmission of various system messages, it may be used to transmit control information of an individual terminal. Through this, the common search space may be used as a solution to a phenomenon that a terminal is not scheduled due to insufficient resources available in a terminal-specific search space.

A search space is a set of candidate control channels including CCEs which a terminal needs to attempt decoding on a given aggregation level, and there are various aggregation levels that make one bundle with 1, 2, 4, and 8 CCEs, so the terminal has a plurality of search spaces. The number of PDCCH candidates which a terminal, within a search space defined according to an aggregation level in an LTE PUCCH, needs to monitor is defined by the following table.

TABLE 1

| Search space Sₖ^{(L)} | | | Number of |
|---|---|---|---|
| | Aggregation | Size | PDCCH |
| Type | level L | [in CCEs] | candidates M^{(L)} |
| UE- | 1 | 6 | 6 |
| specific | 2 | 12 | 6 |
| | 4 | 8 | 2 |
| | 8 | 16 | 2 |
| Common | 4 | 16 | 4 |
| | 8 | 16 | 2 |

According to [Table 1], in a case of a terminal-specific (UE-specific) search space, aggregation levels {1, 2, 4, 8} are supported, and {6, 6, 2, 2} PDCCH candidates are provided, respectively. In a case of a common search space, aggregation levels {4, 8} are supported, and {4, 2} PDCCH candidates are provided, respectively. The reason that the common search space supports only {4, 8} aggregation levels is to improve a coverage characteristic since a system message generally needs to reach an edge of a cell.

DCI transmitted through a common search space is defined only for a specific DCI format such as 0/1A/3/3A/1C which corresponds to a purpose such as power control for a system message or a terminal group, and/or the like. A DCI format with spatial multiplexing is not supported within the common search space. A downlink DCI format which needs to be decoded in a terminal-specific search space is changed according to a transmission mode set for a corresponding terminal. The transmission mode is set through RRC signaling, so a correct subframe number is not specified as to whether the corresponding setting is effective for the corresponding terminal. Therefore, the terminal may be operated so as not to lose a communication by always performing decoding on DCI format 1A regardless of the transmission mode.

In the foregoing description, a method of transmitting and receiving a downlink control channel and downlink control information, and a search space in a conventional LTE and LTE-A have been described.

Hereinafter, a downlink control channel in a 5G communication system will be described with the accompanying drawings.

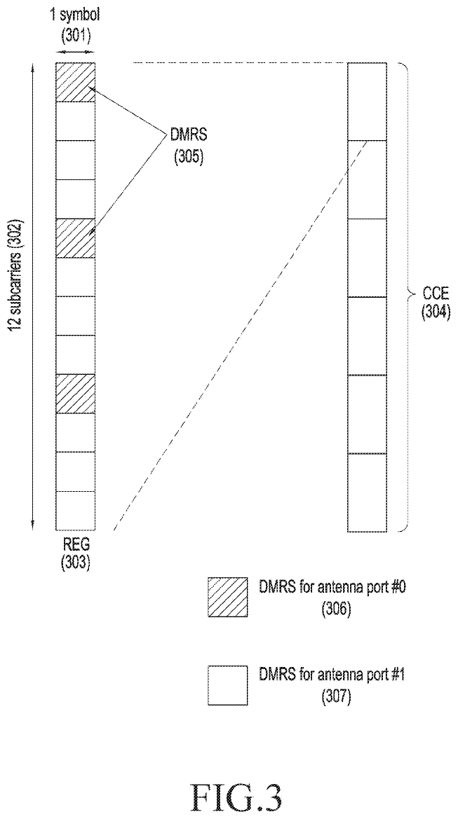

FIG. 3 is a diagram illustrating a transmission resource of a 5G downlink control channel.

More particularly, FIG. 3 is a diagram illustrating an example of a basic unit of time and frequency resources constituting a downlink control channel which may be used in 5G. According to FIG. 3, a basic unit of time and frequency resources constituting a control channel (REG) includes one OFDM symbol 301 on a time axis, and twelve sub-carriers 302, i.e., one RB on a frequency axis. In configuring a basic unit of a control channel, a data channel and a control channel may be time-multiplexed within one subframe by assuming that a basic unit on the time axis is one OFDM symbol 301. By placing the control channel ahead of the data channel, processing time for a user may be reduced, so it is easy to satisfy delay time requirement. By setting a basic unit on the frequency axis for the control channel to one RB 302 including the twelve sub-carriers 302, frequency multiplexing between the control channel and the data channel may be more effectively performed.

A downlink control channel region with various sizes may be set by concatenating REGs 303 as shown in FIG. 3. For example, in a case that a basic unit by which a downlink control channel is allocated is an CCE 304 in 5G, one CCE 304 may include a plurality of REGs 303. Taking the CCE 304 as shown in FIG. 3 as an example, in a case that an REG 303 may include 12 REs, and one CCE 304 includes 6 REGs 303, it means that one CCE 304 may include 72 REs. Once a downlink control region is configured, a corresponding region may include a plurality of CCEs 304. A specific downlink control channel may be mapped to one or more CCEs 304 within the control region based on an aggregation level (AL) and be transmitted. The CCEs 304 within the control region are identified by numbers, and the numbers may be allocated according to a logical mapping scheme.

The basic unit of the downlink control channel, i.e., the REG 303, as shown in FIG. 3, may include REs to which DCI is mapped, and a region to which a DMRS 305 as a reference signal for decoding this is mapped. The DMRS 305 may be mapped and transmitted by considering the number of antenna ports used for transmitting the downlink control channel. FIG. 3 shows an example that two antenna ports are used. At this time, there may be a DMRS 306 which is transmitted for antenna port #0 and a DMRS 307 which is transmitted for antenna port #1. DMRSs for different antenna ports may be multiplexed with various schemes. FIG. 3 shows an example in which DMRSs corresponding to different antenna ports are orthogonally transmitted through different REs, respectively. Like this, the DMRSs may be transmitted after frequency division multiplexing (FDM), or may be transmitted after code division multiplexing (CDM). In addition, there may be various types of DMRS patterns, which may be related to the number of antenna ports.

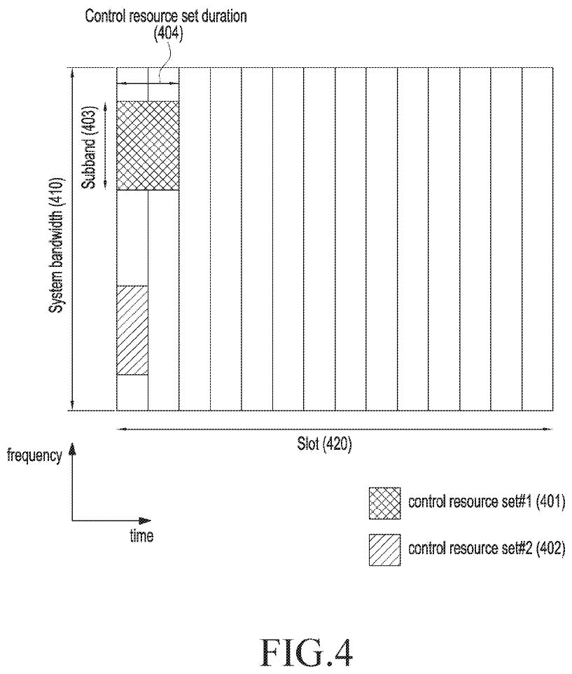

FIG. 4 is a diagram illustrating a transmission resource of a 5G downlink control channel and a 5G downlink data channel.

FIG. 4 illustrates an example of a control region (control resource set (CORESET)) through which a downlink control channel is transmitted in a 5G wireless communication system.

FIG. 4 shows an example in which two control regions (control region #1 (control resource set #1 401) and control region #2 (control resource set #1 402)) are configured within a system bandwidth 410 on a frequency axis and one slot 420 on a time axis. The control regions 401 and 402 may configured by a specific subband 403 within an entire system bandwidth 410 on the frequency axis. The control regions 401 and 402 may configured by one or more OFDM symbols on the time axis, and these may be defined as control region length (control resource set duration) 404. In an example of FIG. 4, the control region #1 401 is configured by control region length of 2 symbols, and the control region #2 402 is configured by control region length of 1 symbol.

A base station may configure the control region in 5G as described above to a terminal through a higher layer signaling (for example, system information, a master information block (MIB), radio resource control (RRC) signaling). Configuring a control region to a terminal means that information such as information about a location of a control region, a subband, resource allocation of the control region, control region length, and/or the like is provided. For example, information shown in Table 2 may be included.

TABLE 2

Configuration information 1: RB allocation information on a
frequency axis
Configuration information 2: Start symbol of a control region
Configuration information 3: Symbol length of a control region
Configuration information 4: Size of REG bundling
Configuration information 5: Transmission mode (Interleaved
transmission scheme or Non-interleaved transmission scheme)
Configuration information 6: Search space type
(a common search space, a group-common search space,
and a terminal-specific search space)
Configuration information 7: Monitoring period
etc.

Various information required to transmit a downlink control channel may be set for the terminal as well as configuration information shown in Table 2.

In a time-frequency domain except for a region where a downlink control channel exists in a control region or control regions, transmission and reception of a downlink data channel are possible, and MAC control elements (CEs) described in the present disclosure are transmitted from a base station to a terminal through the downlink data channel, and the terminal may receive the MAC CEs through the downlink data channel.

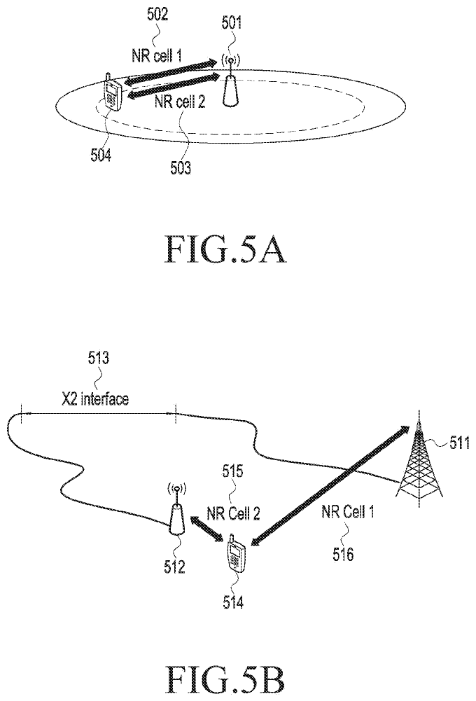

FIG. 5 is a diagram illustrating a communication system according to an embodiment of the present disclosure.

The detailed description will be referred to FIGS. 5a and 5b, and FIG. 5a illustrates a case that NR cell 1 502 and NR cell 2 503 coexist within one small base station 501 in a network according to an embodiment of the present disclosure, and a terminal 504 may transmit and receive data with a base station through the NR cell 1 502 and the NR cell 2 503. In this case, there is no limitation to a duplex scheme, or a licensed band or a unlicensed band of the NR cell 1 502 and the NR cell 2 503. In case that the NR cell 1 502 is a primary cell (Pcell), uplink transmission is performed only through the NR cell 1 502. In case that the terminal 504 may perform uplink transmission through two different cells, and the terminal 504 receives, from the base station 501, a higher signal such that the base station 501 performs the uplink transmission on the NR cell 2 503, the uplink transmission may be performed through the NR cell 1 502 and the NR cell 2 503.

FIG. 5b illustrates a case that a macro base station 511 for a wide coverage, and a transmit-receive point (TRP) or a small base station 512 for increasing data transmission amount are deployed in a network according to another embodiment of the present disclosure. In this case, there is no limitation to a duplex scheme, or a licensed band or a unlicensed band of the macro base station 511, or the TRP or the small base station 512. However, uplink transmission is performed only through the macro base station 511 in case that the macro base station 511 is a Pcell. At this time, it will be assumed that the macro base station 511 and the TRP or the small base station 512 have an ideal backhaul network. So, fast X2 communication 513 between base stations is possible, and even if the uplink transmission is performed only for the macro base station 511, the TRP or the small base station 512 may receive, from the macro base station 511, related control information in real time through the X2 communication 513. In a case that the terminal 514 may perform uplink transmission through two different base stations, the terminal 514 receives, from the macro base station 511, a higher signal such that the TRP or the small base station 512 performs the uplink transmission, the uplink transmission may be performed through the macro base station 511, or the TRP or the small base station 512. At this time, it is assumed that the macro base station 511 and the TRP or the small base station 512 have a non-ideal backhaul network, so transmission and reception between a base station and a terminal is possible.

In the systems of FIGS. 5a and 5b, the NR cell 1 502 and the NR cell 2 503, or the macro base station 511 and the TRP or the small base station 512 may include a plurality of serving cells, and support a total of 32 serving cells. So, solutions proposed in the present disclosure may be applied to all of the systems of FIG. 5a and FIG. 5b.

Hereinafter, a description will be given of how a downlink (DL) carrier and an uplink (UL) carrier are configured and set to a terminal in carrier aggregation (CA).

In the present disclosure, a downlink component carrier may mean a downlink carrier, and an uplink component carrier may mean an uplink carrier.

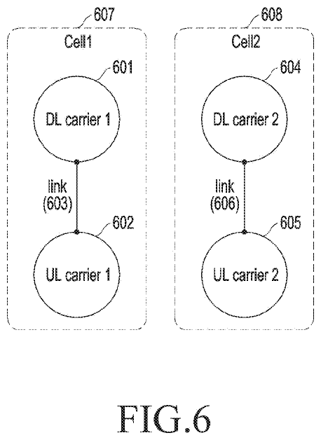

FIG. 6 is a diagram illustrating general 5G carrier aggregation.

In 3GPP LTE Rel-10, a bandwidth extension technology is adopted to support a higher data transmission amount compared to LTE Rel-8. The technique, also called bandwidth extension or carrier aggregation (CA), may extend a band and increase a data transmission amount by the expanded band compared to an LTE Rel-8 terminal which transmits data in one band. Even in 5G, carrier aggregation is supported for an NR carrier, each of the bands for supporting the carrier aggregation is called a component carrier (CC), and an NR terminal generally has one component carrier for each of a downlink and an uplink. In addition, a downlink component carrier and an uplink component carrier which are linked (SIB link, or referred to as an SIB link in the present disclosure) with information through system information are collectively referred to as a cell.

In FIG. 6, a downlink component carrier (downlink (DL) carrier) 1 601 and an uplink component carrier (uplink (UL) carrier) 1 602 are linked by an SIB link 603 and configured as cell 1 607, and a downlink component carrier 2 604 and an uplink component carrier 2 605 are linked by an SIB link 606 and configured as cell 2 608.

An SIB link relation between a downlink component carrier and an uplink component carrier is transmitted through a cell common signal or terminal dedicated signal, and received at a terminal. A terminal supporting CA may receive downlink data and transmit uplink data through a plurality of serving cells.

In a situation that it is difficult for a base station to transmit a physical downlink control channel (PDCCH) to a specific UE on a specific serving cell, a carrier indicator field (CIF) informing that another serving cell transmits a PDCCH and the PDCCH indicates a physical downlink shared channel (PDSCH) or a physical uplink shared channel (PUSCH) of the other serving cell, may be set as a higher signal, and a terminal may know that the carrier indicator field is included in information bits of the PDCCH by receiving the signal. A CIF may indicate another serving cell by adding 3 bits to PDCCH information on a specific serving cell. When the CIF is included in downlink allocation information (DL assignment), the CIF indicates a serving cell to which a PDSCH scheduled by the DL assignment will be transmitted. When the CIF is included in uplink resource allocation information (UL grant), the CIF is defined to indicate a serving cell to which a PUSCH scheduled by the UL grant will be transmitted. For a cell on which a PDSCH is transmitted or a PUSCH is transmitted, a cell index of the cell on which a PDCCH is transmitted and a mapping between a cell on which the PDSCH is transmitted or the PUSCH is transmitted, and a CIF are transmitted through a higher signal in advance and received by a terminal. That is, the terminal receives the higher signal and monitors the PDCCH for the cell on which the PDSCH is transmitted or the PUSCH is transmitted on the cell on which the PDCCH is transmitted and which is indicated by the higher signal, and may know a PDSCH transmitting cell and a PUSCH transmitting cell indicated by a CIF value included in a specific PDCCH received on the cell on which the PDCCH is transmitted, and by the CIF value through the higher signal. Meanwhile, NR assumes up to 16 or 32 serving cell configuration scenarios.

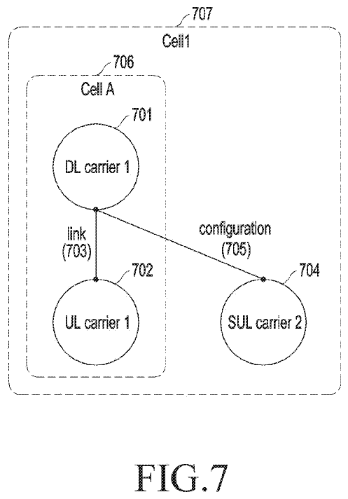

A case that a supplementary uplink carrier (or SUL) as well as 5G uplink and downlink carriers are configured will be described with reference to FIG. 7.

FIG. 7 is a diagram illustrating a case that 5G uplink and downlink carriers and a supplementary uplink carrier are configured according to an embodiment of the present disclosure.

In FIG. 7, a downlink component carrier (downlink (DL) carrier) 1 701 and an uplink component carrier (uplink (UL) carrier) 1 702 are linked by an SIB link 703 to configure cell A 706. At this time, in a case that the cell A 706 is located on a frequency band such as 3.5 GHz, a problem that an uplink transmission coverage of a terminal is reduced occurs due to a characteristic of the frequency band such as 3.5 GHz. In addition, considering a situation in which a frequency of 3.5 GHz is mainly operated by time division duplex (TDD) which divides a downlink slot and an uplink slot in time and uses these, a delay problem for feedback occurs in a case that there is no available uplink slot upon transmitting HARQ-ACK feedback. In order to solve this problem, it is possible to additionally configure an uplink carrier of a low frequency band of, for example, 700 MHz or 1.8 GHz to the cell A 706 and configure the uplink carrier of the low frequency band to be used by the terminal.

FIG. 7 illustrates a structure that a supplementary uplink (SUL) carrier 2 704 is configured (705) to be linked to a downlink component carrier 1 701 in a cell A 706 to be included in a cell 1 707.

In the present disclosure, for convenience of description, the cell A 706 and the cell 1 707 are separated depending on whether the supplementary uplink carrier 2 704 exists, however, only the cell 1 707 including the supplementary uplink carrier 2 704 may be recognized as one cell by a terminal.

Hereinafter, a solution for additionally configuring a supplementary uplink carrier to a cell 1 707, and transmitting and receiving data is provided according to an embodiment of the present disclosure.

### First Embodiment

The first embodiment according to the present disclosure provides a solution for additionally configuring a supplementary uplink carrier to an NR cell, and performing an initial random access, and a solution for setting information about the supplementary uplink carrier for data transmission and reception, and activating/deactivating the supplementary uplink carrier.

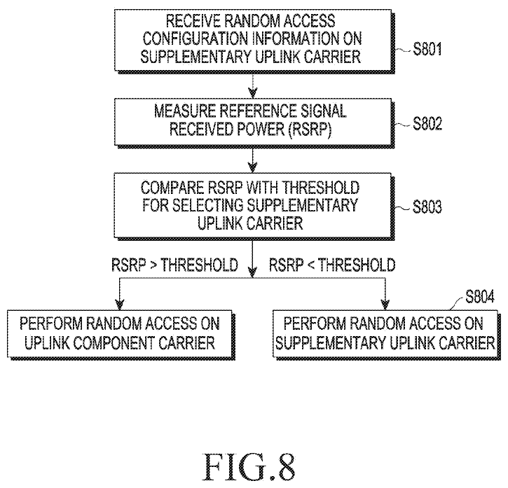

FIG. 8 is a diagram illustrating a method to additionally configure a supplementary uplink carrier for an NR cell and perform an initial random access according to time sequence, according to an embodiment of the present disclosure.

Referring to FIGS. 7 and 8, a base station transmits, to a terminal through a cell common signal on a downlink component carrier 701 of a cell 1 707, random access configuration (random access channel configuration, or RACH configuration) information on a supplementary uplink carrier 704 so that an initial random access may be performed on the supplementary uplink carrier 704, and the terminal receives, through the cell common signal on the downlink component carrier 701 of the cell 1 707, the random access configuration information on the supplementary uplink carrier 704 (S801). The random access configuration information may include location information of a supplementary uplink carrier, band information, time for transmitting a random preamble, frequency information, random preamble sequence information, a threshold for selecting the supplementary uplink carrier, and/or the like.

The terminal measures reference signal received power (RSRP) on the downlink component carrier 701 of the cell 1 707 (S802), compares the measured RSRP with a threshold for selecting the supplementary uplink carrier 704 included in the random access configuration information (S803), and performs a random access on the supplementary uplink carrier 704 only in case that the measured RSRP is less than the threshold (S804).

In case that the measured RSRP is greater than the threshold, the terminal performs the random access on an uplink component carrier 702 of a cell 1 706. The reason for comparing with the threshold through the above RSRP measurement is that a coverage of the uplink component carrier 702 may be known by measuring RSRP of a downlink component carrier 701 using reciprocity of a downlink component carrier and an uplink component carrier in a case of TDD. Therefore, in case that the RSRP value is less than the threshold, it may be determined that the coverage of the uplink component carrier 702 is small, so the terminal performs the random access through the supplementary uplink carrier 704. A process in which the terminal performs an initial random access through the supplementary uplink carrier 704 includes transmitting, by the terminal, a random access preamble on a specific time-frequency resource of the supplementary uplink carrier 704 using the location information of the supplementary uplink carrier, the band information, the time for transmitting the random preamble, the frequency information, and/or the like included in the random access configuration information, and completing, by the terminal, uplink transmission required for a random access procedure on the supplementary uplink carrier 704.

After completing the random access procedure on the supplementary uplink carrier 704, the terminal may additionally receive, from the base station, configuration information about a supplementary uplink carrier through a higher signal. The configuration information about the supplementary uplink carrier may include higher information required for data transmission and reception on the supplementary uplink carrier. For example, the configuration information about the supplementary uplink carrier may include time and frequency resource information per transmission PUCCH format, sequence/frequency hopping information, power control information, and other configuration information for transmitting an uplink control channel, and frequency hopping information and other configuration information for transmitting an uplink data channel.

Hereinafter, a solution for the terminal to activate/deactivate the supplementary uplink carrier after the reception of the configuration information about the supplementary uplink carrier is completed will be described.

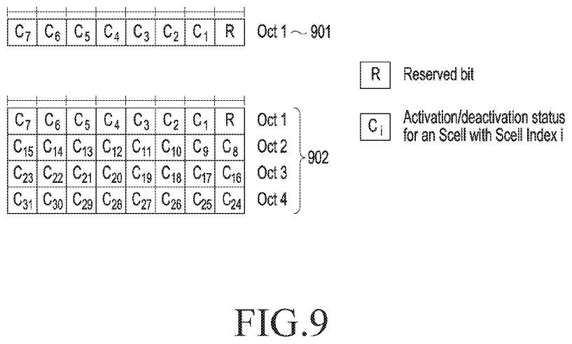

FIG. 9 is a diagram illustrating a solution to indicate activation/deactivation of a supplementary uplink carrier according to an embodiment of the present disclosure.

Oct 1 901 of FIG. 9 may be MAC CE transmission information, which is a higher signal for indicating activation/deactivation of total 5 cells, or DCI transmission information, which is a physical signal. Oct 1 to Oct 4 902 may be MAC CE transmission information for indicating activation/deactivation of up to a total of 32 cells or DCI transmission information. A terminal determines activation/deactivation information of a specific cell or a supplementary uplink carrier through reception of the signal.

At this time, R means a bit which is reserved not to include activation/deactivation information for a specific cell, and Ci means activation/deactivation information for a cell with cell index i when the cell with the cell index i is configured. If C2 is 1, it means that a cell having cell index 2 is activated, and if C2 is 0, it means that the cell having the cell index 2 is deactivated. The terminal may ignore a Ci value having a cell index for a cell which is not configured.

First, the first to third methods in a case that a cell 1 707 including a supplementary uplink carrier 704 is a primary cell (Pcell) will be described. For a terminal, a primary cell means a cell where the terminal receives a synchronization signal, receives a PBCH and an SIB, and performs an initial random access.

In the first method for activation/deactivation of a supplementary uplink carrier proposed in the present disclosure, if a terminal performs an initial random access on the supplementary uplink carrier, the terminal determines that the supplementary uplink carrier is activated without activation indication for the supplementary uplink carrier from a base station, and performs uplink transmission including periodic channel information on the supplementary uplink carrier. At this time, Oct 1 901 or Oct 1 to Oct 4 902 of FIG. 9 does not separately include activation/deactivation information for the supplementary uplink carrier, and, considering a primary cell is always active state, the terminal determines that the supplementary uplink carrier has been deactivated through reception of reconfiguration of the supplementary uplink carrier (for example, including release of the configuration) from a higher signal.

In the second method for activation/deactivation of a supplementary uplink carrier proposed in the present disclosure, if a terminal performs an initial random access on the supplementary uplink carrier, the terminal determines that the supplementary uplink carrier is activated without activation indication for the supplementary uplink carrier from a base station, and performs uplink transmission including periodic channel information on the supplementary uplink carrier. At this time, Oct 1 901 or Oct 1 to Oct 4 902 of FIG. 9 includes activation/deactivation information for the supplementary uplink carrier. Considering a primary cell is always active state, for example, activation/deactivation information of a supplementary uplink carrier 704 in FIG. 7 may be determined to be indicated by a specific Ck. Alternatively, the activation/deactivation information of a supplementary uplink carrier 704 may be determined to be indicated by a reserved bit (R).

In the third method for activation/deactivation of a supplementary uplink carrier proposed in the present disclosure, regardless of whether a terminal performs an initial random access on the supplementary uplink carrier, the terminal determines that the supplementary uplink carrier is activated after receiving activation indication for the supplementary uplink carrier from a base station, and performs uplink transmission including periodic channel information on the supplementary uplink carrier. At this time, Oct 1 901 or Oct 1 to Oct 4 902 of FIG. 9 includes activation/deactivation information for the supplementary uplink carrier. Considering a primary cell is always active state, for example, activation/deactivation information of a supplementary uplink carrier 704 in FIG. 7 may be determined to be indicated by a specific Ck. Alternatively, the activation/deactivation information of a supplementary uplink carrier 704 may be determined to be indicated by a reserved bit (R).

Next, a description will be given of the fourth and fifth methods in a case that a cell 1 707 including a supplementary uplink carrier 704 is a secondary cell. For a terminal, a secondary cell means a cell where the terminal adds for transmitting and receiving a data channel and a control channel based on configuration by a higher signal after the terminal receives a synchronization signal, a PBCH, and an SIB on a primary cell, and performs an initial random access on the primary cell.

In the fourth method for activation/deactivation of a supplementary uplink carrier proposed 704 in the present disclosure, a terminal determines that the supplementary uplink carrier is activated after receiving activation indication for the supplementary uplink carrier from a base station, and performs uplink transmission including periodic channel information on the supplementary uplink carrier. At this time, Oct 1 901 or Oct 1 to Oct 4 902 of FIG. 9 does not separately include activation/deactivation information for the supplementary uplink carrier. So, the terminal determines that the supplementary uplink carrier is activated based on activation information of uplink and downlink component carriers for which the supplementary uplink carrier is configured (cell A 706 of FIG. 7), and performs uplink transmission including periodic channel information on the supplementary uplink carrier. In a case of a secondary cell of which a cell index of a cell 1 707 is 1, C1 indicates activation/deactivation information of the cell A 706, and activation/deactivation information of the cell A 706 is applied as it is for activation/deactivation of the supplementary uplink carrier. So, the terminal determines the activation/deactivation of the supplementary uplink carrier through the activation/deactivation information of the cell A 706.

In the fifth method for activation/deactivation of a supplementary uplink carrier proposed 704 in the present disclosure, a terminal determines that the supplementary uplink carrier is activated after receiving activation indication for the supplementary uplink carrier from a base station, and performs uplink transmission including periodic channel information on the supplementary uplink carrier. At this time, Oct 1 901 or Oct 1 to Oct 4 902 of FIG. 9 includes activation/deactivation information for the supplementary uplink carrier. In a case that a cell index of a cell 1 707 of FIG. 7 is 1, C1 indicates activation/deactivation information of a cell A 706, and activation/deactivation information of a supplementary uplink carrier 704 may be determined to be indicated by C2 next to C1 indicating activation/deactivation information of the cell A 706. Alternatively, the activation/deactivation information of the supplementary uplink carrier 704 may be determined to be indicated by a reserved bit (R). Alternatively, the activation/deactivation information of the supplementary uplink carrier 704 may be determined according to a cell index of the cell 1 707, a CIF value of the cell A 706, and a CIF value of the supplementary uplink carrier 704. For example, if the cell index of the cell 1 707 is 7, a CIF value for scheduling a PUSCH on an uplink component carrier 1 702 by transmitting a PDCCH on a downlink component carrier 1 701 is 3, and a CIF value for scheduling a PUSCH on the supplementary uplink carrier 704 by transmitting the PDCCH on the downlink component carrier 1 701 is 2, C7 according to a cell index may be determined to indicate the activation/deactivation information of the supplementary uplink carrier 704 of which a CIF is a small value, and C8 may be determined to indicate the activation/deactivation information of the cell A 706 of which a CIF is a large value.

After determining activation for the supplementary uplink carrier according to the five methods, the terminal receives, from the base station through a higher signal, configuration indicating whether PUCCH transmission is performed on the uplink component carrier 1 702 or the supplementary uplink carrier 704. The terminal performs PUSCH transmission on a carrier determined for the PUCCH transmission.

Furthermore, the terminal may receive, from the base station through a higher signal, configuration in order that the terminal may be dynamically scheduled for performing the PUCCH transmission on the uplink component carrier 1 702 or the supplementary uplink carrier 704. At this time, a CIF value included in a PDCCH indicates whether the PUSCH transmission is performed on the uplink component carrier 1 702 or the supplementary uplink carrier 704, and the terminal transmits a PUSCH on the uplink component carrier 1 702 or the supplementary uplink carrier 704 according to the CIF value. A mapping relation of the uplink component carrier 1 702 or the supplementary uplink carrier 704 according to the CIF value may be received by the terminal through the higher signal, or may be previously received by the terminal through a higher signal indicating configuration for a supplementary uplink carrier.

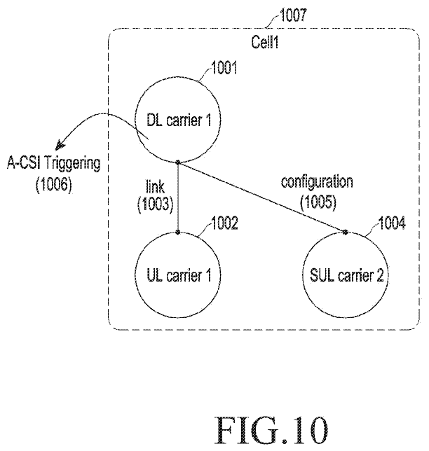

Hereinafter, a solution to trigger aperiodic channel information and transmit channel information for a downlink component carrier in a case that a supplementary uplink carrier is additionally configured for 5G uplink and downlink carriers according to a second embodiment of the present disclosure will be described with reference to FIG. 10.

### Second Embodiment

FIG. 10 is a diagram illustrating a case that aperiodic channel information triggering is transmitted in case that a supplementary uplink carrier is configured for 5G uplink and downlink carriers according to an embodiment of the present disclosure.

In FIG. 10, a 5G downlink component carrier (downlink (DL) carrier) 1001 and a 5G uplink component carrier (uplink (UL) carrier) 1002 are linked with an SIB link relation 1003, and a supplementary uplink (SUL) carrier 1004 is additionally configured through configuration information for the supplementary uplink carrier 1004 for the 5G downlink and uplink component carriers. The SIB link relation 1003 between the component carriers 1001 and 1002, and reception of the configuration information for the supplementary uplink carrier 1004 follows solutions as described in FIGS. 5, 6, 8, and 9 of the present disclosure.

For PUSCH scheduling on the supplementary uplink carrier, despite the fact that a CIF 3-bit field is always present in a PDCCH, the 5G uplink and downlink component carriers and the supplementary uplink carrier are included in one cell, cell 1 1007, so a bit field for requesting aperiodic channel information includes 1 bit. So, a terminal may determine the bit field for requesting the aperiodic channel information as 1-bit bit field on a condition that one or more serving cells are not configured for the terminal, and the condition may be applied so that the terminal determines the bit field for requesting the aperiodic channel information as the 1-bit bit field even if the supplementary uplink carrier is additionally configured for the 5G uplink and downlink component carriers.

In a case that information of the bit field for requesting the aperiodic channel information is ‘1’, the terminal multiplexes the aperiodic channel information on the PUSCH on an uplink component carrier according to a CIF value, and transmits the aperiodic channel information. If the information of the bit field for requesting the aperiodic channel information is ‘0’, only a PUSCH is transmitted on an uplink component carrier according to a CIF value.

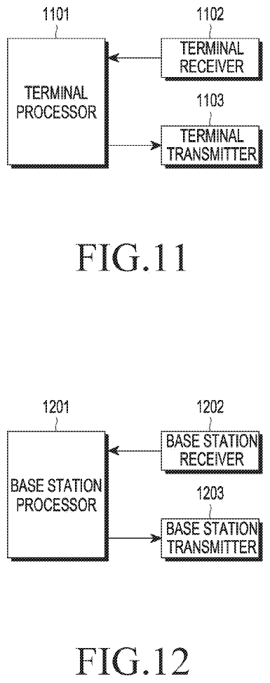

Hereinafter, a terminal and a base station for performing embodiments of the present disclosure will be described with reference to FIGS. 11 and 12. FIGS. 11 and 12 provide a solution for activating/deactivating a supplementary uplink carrier when uplink transmission is performed through the supplementary uplink carrier in a 5G communication system which corresponds to the embodiments. And FIGS. 11 and 12 illustrate a transmission and reception method of the base station and the terminal for applying a method which enables efficient data transmission and reception through transmission and reception of aperiodic channel information by indicating a specific downlink carrier for the transmission and reception of the aperiodic channel information when the supplementary uplink carrier is configured and activated.

FIG. 11 is a diagram illustrating a structure of a terminal apparatus according to an embodiment of the present disclosure.

Referring to FIG. 11, a terminal according to an embodiment of the present disclosure may include a terminal-processor 1101, a terminal-receiver 1102, and a terminal-transmitter 1103.

The terminal-processor 1101 according to an embodiment of the present disclosure may be implemented by a processor included in the terminal, and the terminal-receiver 1102 and the terminal-transmitter 1103 may commonly be referred to as a terminal-transceiver.

The terminal-processor 1101 may control a series of processes which may be executed by the terminal according to the above described embodiment of the present disclosure. For example, the terminal-processor 1101 may control an activation/deactivation method for a supplementary uplink carrier when uplink transmission is performed, a method indicating a specific downlink carrier for transmitting and receiving aperiodic channel information when the supplementary uplink carrier is configured and activated, and/or the like according to an embodiment of the present disclosure.

The terminal-transceiver may transmit and receive a signal with a base station. The signal may include control information and data. For this, a transceiver may include an RF transmitter which up-converts and amplifies a frequency of a transmitted signal, an RF receiver which low-noise amplifies and down-converts a received signal, and/or the like. The transceiver may receive a signal through a wireless channel to output it to the terminal-processor 1101, and transmit a signal output from the terminal-processor 1101 through a wireless channel.

FIG. 12 is a diagram illustrating a structure of a base station apparatus according to an embodiment of the present disclosure.

Referring to FIG. 12, a base station according to an embodiment of the present disclosure may include a base station-processor 1201, a base station-receiver 1202, and a base station-transmitter 1203.

The base station-processor 1201 according to an embodiment of the present disclosure may be implemented by a processor included in the base station, and the base station-receiver 1202 and the base station-transmitter 1203 may commonly be referred to as a base station-transceiver.

The base station-processor 1201 may control a series of processes which may be executed by the base station according to the above described embodiment of the present disclosure. For example, the base station-processor 1201 may control an activation/deactivation method for a supplementary uplink carrier when uplink transmission is performed, a method indicating a specific downlink carrier for transmitting and receiving aperiodic channel information when the supplementary uplink carrier is configured and activated, and/or the like according to an embodiment of the present disclosure.

The base station-transceiver may transmit and receive a signal with a terminal. The signal may include control information and data. For this, a transceiver may include an RF transmitter which up-converts and amplifies a frequency of a transmitted signal, an RF receiver which low-noise amplifies and down-converts a received signal, and/or the like. The transceiver may receive a signal through a wireless channel to output it to the base station-processor 1201, and transmit a signal output from the base station-processor 1201 through a wireless channel.

The embodiments of the present disclosure shown in the specification and the drawings are merely presented to easily describe technical contents of the present disclosure and help the understanding of the present disclosure and are not intended to limit the scope of the present disclosure. That is, it will be clear to those skilled in the art of the present disclosure that other modified embodiments which are based on the technical contents of the present disclosure may be implemented. Further, each of the embodiments may be combined and operated if necessary. For example, a base station and a terminal may be operated by combining some of all embodiments of the present disclosure.

The exemplary method diagrams, system configuration diagrams, and apparatus diagrams, and so on illustrated in FIGS. 1 to 12 are not intended to limit the scope of the present disclosure. That is, all components or operations illustrated in FIGS. 1 to 12 should not be interpreted as essential to implementation of the present disclosure. Rather, even when only a part of the components are included, the present disclosure may be implemented without departing from the scope of the present disclosure.

The afore-described operations may be performed by providing a memory storing a related program code in any component of a base station or a terminal apparatus in a communication system. That is, a controller of the base station or the terminal apparatus may perform the operations by reading the program code from the memory and executing the program code by a processor or a central processing unit (CPU).

Various components and modules of the base station or the terminal apparatus as described in the present disclosure may operate in a hardware circuit such as a combination of a complementary metal oxide semiconductor-based logic circuit, firmware, and/or hardware, and firmware and/or software inserted into a machine-readable medium. For example, various electric structures and methods may be implemented using electric circuits such as transistors, logic gates, or application specific integrated circuits.

While the disclosure has been shown and described with reference to certain exemplary embodiments thereof, various changes in form and details may be made therein without departing from the scope of the present disclosure. Therefore, the scope of the present disclosure should not be limited to the described embodiments, and should be defined by the following appended claims and equivalents thereof.

1. A method to transmit and receive data through a supplementary uplink (SUL) carrier in a wireless communication system, the method comprising:
receiving, from a base station, random access channel (RACH) configuration information on a supplementary uplink (SUL) carrier through a cell common signal of a downlink carrier;
measuring reference signal received power (RSRP) on the downlink carrier;
comparing the measured RSRP with a threshold for selecting the SUL carrier; and
determining whether to perform a random access on the SUL carrier based on the measured RSRP and the compared result of the threshold,
wherein the threshold for the selecting the SUL carrier is included in the RACH configuration information.

2. The method of claim 1, further comprising:
performing the random access on the SUL carrier in case that the measured RSRP is less than the threshold.

3. The method of claim 2, further comprising:
receiving configuration information about the SUL carrier,
wherein the configuration information about the SUL carrier includes information required for data transmission and reception on the SUL carrier.

4. The method of claim 2, further comprising:
receiving, from the base station, information indicating activation or deactivation of the SUL carrier.

5. The method of claim 4, further comprising:
performing uplink transmission on the SUL carrier without indication of deactivation for the SUL carrier; and
determining whether to activate or deactivate the SUL carrier based on the information indicating the activation or deactivation of the SUL carrier which is received from the base station.

6. The method of claim 4, further comprising:
performing uplink transmission on the SUL carrier in case that the information indicating the activation of the SUL carrier is received through the signal received from the base station.

7. The method of claim 4, wherein the information indicating the activation or deactivation of the SUL carrier includes a cell index.

8. The method of claim 7, wherein the information indicating the activation or deactivation of the SUL carrier includes activation or deactivation information about a cell which corresponds to the cell index.

9. The method of claim 2, wherein the downlink carrier is system information block (SIB) linked with an uplink carrier, and the downlink carrier and the uplink carrier which are SIB linked and the SUL carrier are included in one cell.

10. The method of claim 9, wherein a bit field for requesting aperiodic channel information includes 1 bit.

11. A method to transmit and receive data through a supplementary uplink (SUL) carrier in a wireless communication system, the method comprising:
transmitting, to a terminal, random access channel (RACH) configuration information on a SUL carrier through a cell common signal of a downlink carrier, the RACH configuration information including a threshold for selecting the supplementary uplink carrier;
transmitting, to the terminal, configuration information about the SUL carrier including information required for data transmission and reception on the SUL carrier; and
transmitting, to the terminal, a signal including information indicating activation or deactivation of the SUL carrier,
wherein whether to perform a random access on the SUL carrier is determined based on the threshold.

12. The method of claim 11, wherein the random access on the SUL carrier is performed in case that reference signal received power (RSRP) measured on the downlink carrier is less than the threshold.

13. A terminal to transmit and receive data through a supplementary uplink (SUL) carrier in a wireless communication system, the terminal comprising:
a transceiver coupled with a processor; and
the processor configured to:
receive, from a base station, random access channel (RACH) configuration information on a SUL carrier through a cell common signal of a downlink carrier measure reference signal received power (RSRP) on the downlink carrier, compare the measured RSRP with a threshold for selecting the SUL carrier, and determine whether to perform a random access on the SUL carrier based on the measured RSRP and the compared result of the threshold,
wherein the threshold for the selecting the SUL carrier is included in the RACH configuration information.

14. (canceled)

15. A base station to transmit and receive data through a supplementary uplink (SUL) carrier in a wireless communication system, the base station comprising:
a transceiver coupled with a processer; and
the processor configured to:
transmit, to a terminal, random access channel (RACH) configuration information on a SUL carrier through a cell common signal of a downlink carrier, the RACH configuration information including a threshold for selecting the SUL carrier,
transmit, to the terminal, configuration information about the SUL carrier including information required for data transmission and reception on the SUL carrier, and
transmit, to the terminal, a signal including information indicating activation or deactivation of the SUL carrier,
wherein whether to perform a random access on the SUL carrier is determined based on the threshold.

16. The method of claim 11, wherein the information indicating the activation or deactivation of the SUL carrier includes a cell index.

17. The method of claim 16, wherein the information indicating the activation or deactivation of the SUL carrier includes activation or deactivation information about a cell which corresponds to the cell index.

18. The terminal of claim 13, wherein the processor is further configured to:
perform the random access on the SUL carrier in case that the measured reference signal received power is less than the threshold.

19. The terminal of claim 13, wherein the processer is further configured to:
receive configuration information about the SUL,
wherein the configuration information about the SUL carrier includes information required for data transmission and reception on the SUL.

20. The base station of claim 15, wherein the random access on the SUL is performed in case that reference signal received power (RSRP) measured on the downlink carrier is less than the threshold.

21. The base station of claim 20, wherein the information indicating the activation or deactivation of the SUL carrier includes a cell index.
